(19) United States
(12) Patent Application Publication
(10) Pub. No.: US 2025/0212877 A1
(43) Pub. Date: Jul. 3, 2025

(54) SUGAR-CONTAINING COMPOSITION FOR FOLIAR SPRAY AND METHOD OF USING THE SAME

(71) Applicant: KOREA RESEARCH INSTITUTE OF CHEMICAL TECHNOLOGY, Daejeon (KR)

(72) Inventor: Ju Hyun YU, Daejeon (KR)

(21) Appl. No.: 18/837,699

(22) PCT Filed: Feb. 17, 2023
(86) PCT No.: PCT/KR2023/002358

§ 371 Date: Mar. 21, 2025

(30) Foreign Application Priority Data
Feb. 18, 2022 (KR) 10-2022-0021692

(51) Int. Cl. A01N 43/16; A01N 25/06; A01N 25/14; A01N 43/08; A01P 15/00; A01P 21/00

(52) U.S. Cl. CPC A01N 43/16; A01N 25/06; A01N 25/14; A01N 43/08; A01P 15/00; A01P 21/00

(57) ABSTRACT

A sugar composition of the present invention is a formulation containing sugar that can be easily absorbed into plant leaves and stems and immature fruits. When the sugar composition is diluted or dissolved in water and sprayed onto plant leaves and stems and immature fruits, sugar is rapidly absorbed into a plant and translocated like sugar produced through photosynthesis, and thus, the sugar composition can exhibit various effects such as plant growth promotion, fruit fattening, fruit coloring promotion, and increased sugar content in fruits. In addition, since sugar is rapidly absorbed into the inside of leaves after being sprayed onto the leaves, there is the effect in which the concentration of sugar remaining on the surface is rapidly lowered, and thus, the sugar composition can be safety used in the control of pest such as mites and aphids.

### TECHNICAL FIELD

The present disclosure relates to a sugar formulation for foliar spray that is diluted with water and sprayed onto plant leaves and stems and unripe fruits to regulate plant growth and make fruits larger and sweeter and a method for preparing the same.

More particularly, the present disclosure relates to a sugar composition for foliar spray including 10 wt % or more of sugar and 1 wt % or more of an adjuvant, and a dilute solution of the sugar composition according to the present disclosure is sprayed onto leaves of at least one type of plant selected from the group consisting of vegetables, fruits, grains and fruit trees, to increase the sugar content in plants, enhance the size or number of plants and obtain the pest control effect for plants and a method of using the same.

The present application claims priority to Korean Patent Application No. 10-2022-0021692 filed on Feb. 18, 2022 in the Republic of Korea, the disclosure of which is incorporated herein by reference.

### BACKGROUND

Plants synthesize glucose, ATP and NADPH in the chloroplast from carbon dioxide absorbed through pores in their leaves, water absorbed by roots and light captured by chlorophyll. This process is called photosynthesis, and plants convert sunlight to chemical energy necessary for growth through photosynthesis and store the energy and produce carbohydrates that constitute the plant body, and make fats and proteins from the carbohydrates. Glucose made in the photosynthesis is converted to sucrose which is a disaccharide with low reactivity in the cytoplasm and moves to growing points, roots and fruits where plants need sugar, and is used to form the plant body together with macronutrients such as nitrogen, phosphorus, potassium, calcium, sulfur and magnesium and micronutrients such as iron, boron, chlorine, manganese, zinc, copper, molybdenum and nickel, which are absorbed through roots or leaves. In particular, the sucrose that has moved into the fruits is stored as starch and during ripening of fruits, the starch is converted to monosaccharides such as glucose and fructose or sucrose again, giving a sweet taste.

However, in environments in which photosynthesis efficiency is low, i.e., when the amount of light is too low or higher than the light saturation point, when the temperature is too low or too high, or when water and nutrients are insufficiently or excessively supplied, low photosynthesis efficiency or high respiration rate hinders plant growth and results in low sugar content in fruits. In the event of poor or slow plant growth, absorption of water and nutrients through roots reduces, and rather, in many cases, various types of fertilizers or plant nutrients supplied to the soil hinder the plant growth. In this case, it is the best to optimize the cultivation environment to promote photosynthesis, i.e., adjust the amount and intensity of light and temperature within the optimal range and supply sufficient water and carbon dioxide.

To promote crop growth and make fruits big and sweet, farmers often use plant nutrients to spray onto leaves (foliar spray), and the plant nutrients may be largely classified into two. The first one is an inorganic salt formulation primarily containing nitrogen, phosphorus and potassium (macronutrients), and a small amount of micronutrients such as sulfur, calcium, magnesium, iron, molybdenum and boron, and an example of a product that is available to ordinary consumers may be DAEYU's Mulpure A, B. This formulation is absorbed through roots or leaves and plays many roles in the plant body to promote normal plant growth. The other plant nutrient is an amino acid formulation primarily containing animal or plant amino acids. This amino acid formulation may help the crops make various types of proteins including chlorophyll, using less energy in the plant's body to encourage plants to overcome stress and normally grow in environments that are not favorable for photosynthesis (Wikipedia, plant nutrition). Another product is a starfish fermentation product containing inorganic salts and amino acids (made by Ire Bio, Korea) (Korean Patent No. 10-1100666), and this product uses starfish as the main raw material and sugars or molasses as an energy source for microorganisms for quick microbial fermentation of starfish, but presumably, a large amount of inorganic salts and a small amount of amino acids which are not fermented any more remain after the completion of fermentation.

The plant nutrients sprayed onto leaves are primarily absorbed through pores (stomata) in the leaves, so the absorption rate is not only slow, and but the quantity is also small. In general, the amount of absorption in the upper surface of leaves having a smaller number of pores is very small, and the amount of absorption in the lower surface of leaves having a larger number of pores is larger than the amount of absorption in the upper surface. Except the pores, the upper and lower surfaces of leaves are covered with a hydrophobic wax layer, and do not get wet with water, and most of materials including water cannot penetrate the layer, but in general, materials having the molecular weight of 300 or less may be absorbed in a very small amount by diffusion that occurs due to a concentration difference. However, because highly hydrophilic materials are difficult to penetrate the extremely hydrophobic wax layer, experts predict that there may be an extremely small amount of absorption of inorganic salts or amino acids that are ionic.

These formulations may help plants produce chlorophyll when absorbed into the plant body, thereby promoting the normal growth of crops and making fruits big and sweet, but normally, the effect is slowly exhibited after the nutrients are applied. Additionally, in environments that are not favorable for photosynthesis, the effect of the formulations may reduce and absorption and translocation may be hindered, often causing phytotoxicity.

A plant biostimulant (or a plant booster) promotes at least one process in living things, and is not essential for plants. Nevertheless, because the plant biostimulant greatly affects the plant processes, it is defined as a substance that gives a positive result to farmers (http://www.canna-uk.com/booster). One of examples is CANNABOOST Accelerator (made by CANNA, UK), and this formulation uses different oligosaccharides as the main ingredient, and promotes flower differentiation. Japanese Patent Publication No. 2014-40338 discloses a plant biostimulant including vegetable oil and fatty alcohol to promote plant growth, and Japanese Patent No. 4879578 and Japanese Patent No. 4368564 disclose plant boosters including monovalent alcohol having 12 to 24 carbon atoms.

Additionally, farmers often spray a sugar solution or a molasses aqueous solution as a plant stimulant to promote the growth of vegetable crops (https://www.youtube.com/watch?v=QZLGVg7ZflI&t=800s). However, the amount of sugar absorbed through leaves is extremely small and there is little or no effect, but because high concentration sugar remains on the leaf surface for a long time, the growth is notably suppressed and the leaf surface is contaminated or stained with fungus, resulting in low product quality. By this reason, experts do not recommend using sugar solutions as a foliar spray. When sugar solutions are used for eco-friendly pest control, it is recommended to wash with water in one or two days after spraying.

Accordingly, in environments that are not favorable for efficient photosynthesis of crops such as long-term rainfall or continued low temperature when growing crops, to increase the sugar content in fruits in a short time, it is general to raise the temperature in cultivation facilities by increasing the light intensity even in daytime or operating boilers for a long time, and there is no other special means.

### SUMMARY

### Technical Problem

The inventors have expected that when sugar is fed from the outside like glucose injection often used in people who are weak, the sugar is absorbed through leaves or stems, and is translocated at a very high speed like glucose produced by photosynthesis in cytoplasm, thereby promoting fruit enlargement and coloring and increasing sugar content in fruits.

After spraying glucose or sucrose onto some types of crops, for example, cucumber, tomato and strawberry, as a result of measuring the rate of absorption through leaves, the result showed little or no absorption as predicted. However, it was confirmed that when some adjuvants were selected and sprayed onto leaves, stems and unripe fruits together with sugar, sugar absorption was highly promoted. As a result of testing the physiological effect of the sugar containing formulation on some types of crops, the absorption of water through roots immediately after foliar spray was increased several times than non-treatment, and there were very preferable effects on such as fruit fattening and sweetening. Accordingly, in efforts to prepare a sugar formulation for foliar spray that is effective in enhancing the fruit fattening and increasing the sugar content in environments in which photosynthesis efficiency is low, the present disclosure was completed.

### Technical Solution

The present disclosure provides a new concept of sugar-containing plant booster (hereinafter, referred to as a “sugar composition”) for foliar spray containing sugar such as glucose, fructose, xylose, arabinose, galactose, mannose and sucrose as the main ingredient and adjuvants to increase the absorption of the sugar through plant leaves.

The present disclosure provides a liquid formulation in which the sugar, the adjuvant and an additive are added, dissolved and mixed in an aqueous solution containing water or an aqueous organic solvent, a water-soluble powder formulation prepared by mixing and grinding the powdered sugar, the adjuvant and the additive and a water-soluble granule formulation prepared by mixing and granulating all the ingredients for water-soluble use.

The present disclosure further provides a method of using the sugar composition of the present disclosure including diluting or dissolving in water and spraying one or more times onto leaves of at least one type of plant selected from the group consisting of vegetables, fruits, grains and fruit trees to improve the sugar content in plants, enhance the size or number of plants and achieve pest control for plants.

### Advantageous Effects

When the sugar composition of the present disclosure is diluted or dissolved in water and sprayed onto plant leaves, stems and unripe fruits, it is quickly absorbed into the plant body and translocated like sugar produced by photosynthesis, thereby promoting fruit fattening and coloring and increasing the sugar content.

Additionally, because it is quickly absorbed through leaves after spraying, the concentration of sugar remaining on the surface is lowered at a high speed, so it may be safely used to control pests such as mites, aphids or powdery mildews.

### BRIEF DESCRIPTION OF THE DRAWINGS

FIG. 1 shows growth promotion, fruit fattening and increased sugar content in each part of the plant body by sugar translocation after foliar spraying of a sugar composition according to an embodiment of the present disclosure.

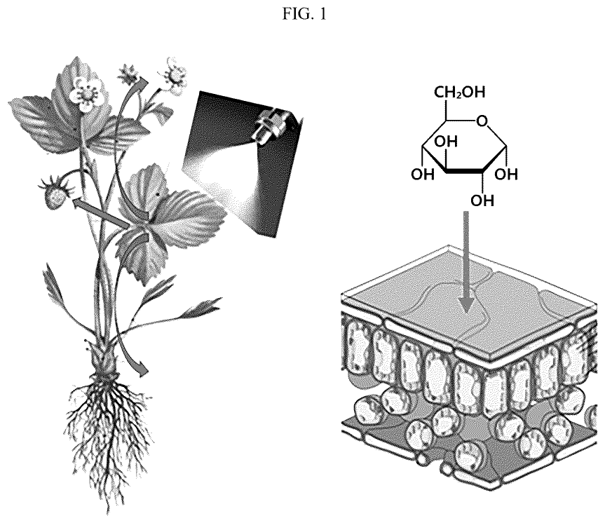

FIG. 2 shows the principle in which sugar absorbed into the plant body by foliar spraying of a sugar composition according to an embodiment of the present disclosure is converted to sucrose in cytoplasm, translocated and stored as starch in fruits, making fruits ripen and then hydrolyzed, increasing the sugar content in fruits.

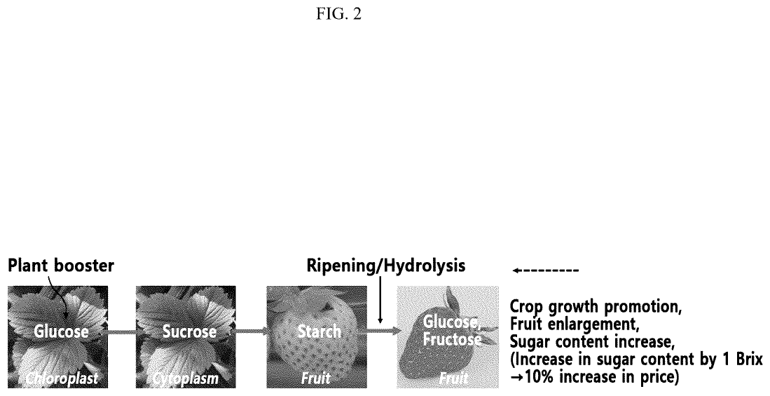

FIG. 3 is a graph showing glucose absorption rate in 24 hours after cucumber foliar spray of a composition according to an embodiment of the present disclosure.

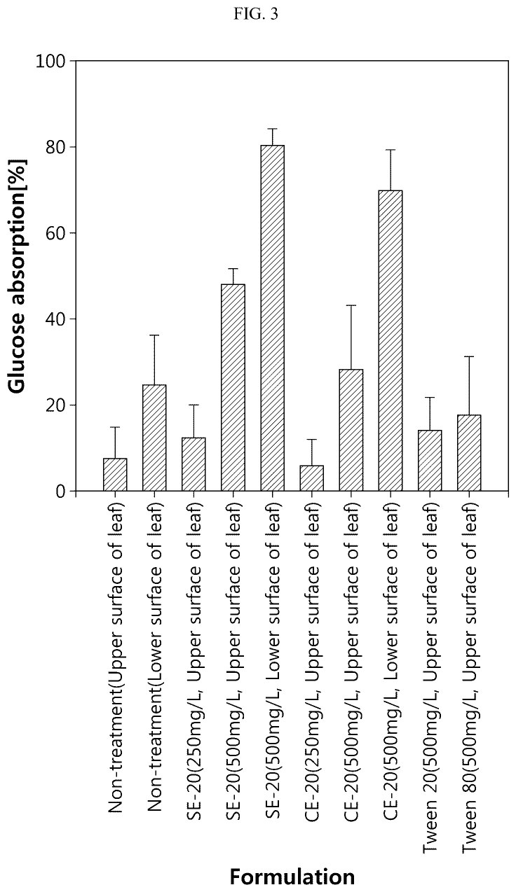

FIG. 4 shows glucose absorption rate over time after a sugar composition according to an embodiment of the present disclosure is sprayed onto tomato leaf surface.

### DETAILED DESCRIPTION

Hereinafter, the present disclosure will be described in detail. It should be understood that the terms or words used in the specification and the appended claims should not be construed as limited to general and dictionary meanings, but rather interpreted based on the meanings and concepts corresponding to the technical aspect of the present disclosure on the basis of the principle that the inventor is allowed to define terms appropriately for the best explanation.

The term “vegetable” as used herein refers collectively to vegetables of which leaves, stems or roots are used, such as Chinese cabbage, lettuce, spinach, crown daisy, cabbage, broccoli, curled mallow, chives, radish, carrot, “fruit” refers collectively to vegetables having edible fruits, such as strawberry, tomato, oriental melon, water melon, eggplant, cucumber, bell pepper, paprika, zucchini and pepper, “grain” refers to all food crops that are eaten as staple or non-staple food by humans and animals, such as rice, wheat, barley, bean, corn, and “fruit tree” refers collectively to woody plants and grass plants having edible fruits, such as grape, apple, pear, banana, mango, pineapple and kiwi.

Additionally, “foliar spray” as used herein refers to spraying an aqueous solution prepared by diluting a sugar composition in water onto plant leaves, stems and unripe fruits. This concept is different from soil or plant root treatment. Accordingly, when the composition of the present disclosure is diluted in water and sprayed onto the aerial parts of plants, the main part that quickly absorbs sugar is leaves, stems and unripe fruits covered with a wax layer on the surface, and include upper and lower leaf surfaces.

To solve the above-described problem, the present disclosure provides a sugar composition for foliar spray including 10 wt % or more of sugar; and 1 wt % or more of an adjuvant.

According to an embodiment of the present disclosure, the plant may include at least one selected from the group consisting of vegetables, fruits, grains and fruit trees defined and described above.

According to an embodiment of the present disclosure, the sugar may include at least one selected from the group consisting of glucose, fructose, xylose, arabinose, galactose, mannose and sucrose. Raw sugar containing impurities that are not absorbed through leaves and remain on the surface in an amount of less than 10% of the raw sugar when the sugar composition is diluted in water and sprayed onto plant leaves may be used as the raw material of sugar even though it is not purified at high level, and its example may include purified anhydride, a water-containing substance in which water is present in crystalline form and a high concentration syrup. Additionally, hydrolysis products of molasses-based biomass juice concentrate, for example, sugar cane, sweet beet, corn stem and sweet sorghum, molasses remaining after recovery of sugar or hydrolysis products of molasses, fermentable sugar made of plant biomass as raw material, seaweed derived sugar hydrolysis products may be used.

When the sugar composition of the present disclosure is used to promote fruit fattening, or increase the sugar content in fruits, the sugar as the ingredient of the formulation may contain at least one of glucose, fructose, a mixture of glucose and fructose or sucrose. The glucose and fructose can be freely converted to each other in the plant cell, and their ratio in the formulation may be freely adjusted. However, because the sugar formulation containing sucrose is absorbed more slowly than glucose or fructose according to the type of crop, it is expected that the physiological effect may be exhibited slowly. Because the behaviors of sugar in the plant body are known as reaction commonly occurring in most of plants, the sugar composition of the present disclosure may be used in not only fruits but also all crops including vegetables, fruit trees and grains.

The sugar composition of the present disclosure is quickly absorbed through leaves by the adjuvant after spraying an aqueous solution prepared by dissolving or diluting in water, and thus sugar hardly remains on the leaves after a day or two or three days.

In the composition of the present disclosure, a solvent that dissolves the sugar is mainly deionized water, and may include an aqueous organic solvent to dissolve the additive and ensure the physicochemical stability of the formulation, and its example may include glycerol, ethanol, methylpropyleneglycol, butyltriglycol and methylpropylenediglycol, but is not limited thereto and may include any solvent that can mix with sugar or nonionized water.

The sugar composition for foliar spray of the present disclosure includes the adjuvant as the essential ingredient to promote the absorption of the sugar in plant leaves. According to an embodiment of the present disclosure, the adjuvant may include at least one selected from the group consisting of fatty alcohol polyoxyethylene ether, polyoxyethylene fatty acid ester, polyoxyethylene sorbitan fatty acid ester and polyoxyethylene sucrose fatty acid ester.

Additionally, the fatty alcohol in the fatty alcohol polyoxyethylene ether may be at least one selected from the group consisting of butanol, octanol, a decyl/dodecyl alcohol mixture, lauryl alcohol, isododecyl alcohol, tridecyl alcohol, secondary alcohol having 12 to 14 carbon atoms, cetyl alcohol, stearyl alcohol, oleyl alcohol and castor oil, and the fatty acid in the polyoxyethylene fatty acid ester may include at least one selected from the group consisting of lauric acid, stearic acid, oleic acid and coconut fatty acid.

In the sugar composition of the present disclosure, the moles of ethylene oxide added (or degree of polymerization) in a nonionic surfactant with polyoxyethylene as a hydrophilic group, included as the adjuvant for foliar adsorption of sugar, are suitably from 5 mol to 60 mol and preferably from 10 mol to 40 mol although it may slightly differ for each crop such as cucumber, strawberry, tomato. The hydrophobic fatty alcohol or fatty acid in the fatty alcohol polyoxyethylene ether and the polyoxyethylene fatty acid ester preferably contains the hydrophobic group having 12 to 22 carbon atoms to maximize the foliar absorption increase effect of sugar. In summary, polyoxyethylene aliphatic alcohol ethers with 9 to 40 moles of ethylene oxide in the hydrophilic group and 12 to 22 carbons in the hydrophobic group or polyoxyethylene fatty acid esters with 12 to 22 carbons in the hydrophobic group are preferred.

According to one embodiment of the invention, said sugar composition may further comprise an inorganic salt, without impairing the chemical stability of the formulation, in order to facilitate the foliar uptake of the sugar after foliar uptake of the sugar, to facilitate the production of chlorophyll, or to facilitate the foliar uptake of the sugar by keeping the spray droplets in an aqueous solution or by absorbing water after foliar spraying, further comprising at least one water-soluble salt selected from the group consisting of calcium salts, calcium salts and magnesium salts, and more particularly potassium chloride, potassium sulfate, potassium carbonate, potassium phosphate, potassium nitrate, calcium chloride, magnesium chloride, magnesium sulfate, and the like.

The ratio of sugar in the sugar composition of the present disclosure is 10% or more of the total formulation, and when considering the additive such as the adjuvant for foliar absorption of sugar, preferably, the ratio of sugar does not exceed 90%. The formulation may include at least one type of adjuvant, and the ratio of adjuvant may vary depending on the ratio of sugar which is the main ingredient, but is preferably 1% or more and 20% or less.

The sugar composition for foliar spray of the present disclosure may be prepared in a liquid formulation using water as a main solvent, or a water-soluble powder formulation by reducing all the ingredients to a powder. Additionally, the sugar composition for foliar spray of the present disclosure may be prepared in a water-soluble granule formulation by forming granules from the powder.

The sugar composition according to an embodiment of the present disclosure may be sprayed onto leaves of plants (foliar spraying) to increase the sugar content in plants, or enhance the size or number of plants.

According to an embodiment of the present disclosure, there is provided a method of using a composition for foliar spray including the steps of dissolving the sugar composition of the present disclosure containing 10% or more of sugar in water to prepare an aqueous solution having the sugar concentration of 20,000 mg/L or less; and foliar spraying the sugar solution one or more times to at least one type of plant selected from the group consisting of vegetables, fruits, grains and fruit trees.

The sugar composition of the present disclosure may be diluted in water to prepare a sugar aqueous solution having the sugar concentration of 20,000 mg/L or less, and when considering safety of plants by the osmotic pressure in plant cells in which sugar absorption sharply rises, and the sugar concentration in the aqueous solution is preferably 10,000 mg/L or less, and more preferably 5,000 mg/L or less.

When the sugar composition of the present disclosure is diluted in water to prepare an aqueous solution for foliar spray, the concentration of the adjuvant for increasing the absorption of sugar by plant leaves is preferably 1,000 mg/L or less, and when considering the phytotoxicity risk by the adjuvant accumulated on plant leaves by repeated spraying, the concentration of the adjuvant is more preferably 500 mg/L or less.

When the sugar composition of the present disclosure is diluted in water to prepare an aqueous solution for foliar spray, a spreader may be used to improve the spreading, wetting and penetration efficacy to easily stick to plant leaves and spread wide, and in this instance, examples of available spreaders may include Dongbang spreader (made by Dongbang Agro, Korea), and it is preferable to add in the amount recommended by the manufacturer.

The sugar composition of the present disclosure may be generally sprayed by the similar method to fertilizers for foliar feeding such as inorganic salt formulations or amino acid formulations. Absorption promotion is better at high humidity than at low humidity, and it may be used very safely unless it is used in high temperature condition or when the plant body is dry. In view of this environment, it is preferable to use in the morning or evening rather than at day.

The composition of the present disclosure may be designed for 80% or more of loaded sugar to be absorbed within 48 hours to 96 hours after foliar spraying, and may be designed to be absorbed at a lower speed.

According to an embodiment of the present disclosure, the method of using may be configured to improve the sugar content in plants, enhance the size or number of plants, or control pests in plants or prevent cold weather damage.

When glucose or fructose is the main ingredient, the sugar composition of the present disclosure may be sprayed onto young plants of vegetables or fruits at low concentration to promote growth, leading to slow increase in fresh weight. When sunlight lacks due to cloudy weather, it may be used to make up for deficiency of photosynthesis, thereby promoting growth, contributing to growth close to normal growth.

The sugar composition of the present disclosure may be used at the fruit enlargement stage to increase fruit size or shorten the fruit harvesting period, thereby increasing the amount of fruits harvested, and may be used 3 days or a week or 10 days or 20 days or 30 days before harvest to greatly increase the sugar content. In particular, the sugar composition of the present disclosure may be used for fruits including unripe fruits 2 or 3 times or continuously at the interval of 2 days or 3 days or 4 days or 5 days or 7 days or 10 days to significantly increase the sugar content in fruits. Additionally, it stays fruits firm according to the type of fruit, for example, tomato or strawberry, to improve the shelf life of fruits.

The sugar-containing plant stimulant of the present disclosure is quickly absorbed through leaves by the adjuvant after it is sprayed as an aqueous solution, and when a day, two days or three days have passed, little or no sugar is left on leaves. Accordingly, it is used as eco-friendly pest control formulation to control pests primarily found in leaves such as aphids, mites or powdery mildews, leaving little or no stain or phytotoxicity on leaves.

The sugar-containing plant stimulant of the present disclosure may sharply increase the sugar concentration in mesophyll cells, and when temporary temperature drop is forecast in the late autumn, it may be sprayed onto crops to prevent cold weather damage.

Hereinafter, exemplary embodiments and examples of the present disclosure will be described with reference to the accompanying drawings in sufficient detail for persons having ordinary skill in the technical field pertaining to the present disclosure to easily carry out the invention. In particular, the technical aspect of the present disclosure and the essential components and their functions are not limited thereto. Additionally, the present disclosure may be modified in many other forms, and is not limited to the disclosed embodiments and examples.

In the following Example and Experimental Example, % used in the composition of the sugar formulation refers to wt % unless otherwise indicated, and the foliar absorption rate of sugar indicates the ratio of sugar estimated to have been absorbed through leaves because sugar was not collected by cleaning the leaves among the total sugar loaded onto the leaves.

### <Experimental Example 1> Measurement of Crop Foliar Absorption Rate of Different Types of Sugars and the Sugar Composition of the Present Disclosure

To measure the plant foliar absorption rate of sugar, Congo red method was used (Korean Patent No. 0314600, Yu et al., Pest Management Science (2001) 57, 564-569). In glass greenhouse, cucumber (Korean White, made by Farm Hannong, Korea) and tomato (Seogwangtomato, made by Farm Hannong, Korea) seeds were sown to raise plants. The young plants were transplanted to a vinyl cup having a diameter of 10 cm and cucumber was cultivated up to 4.5-leaf stage and tomato was cultivated up to 6.5-leaf stage. Strawberry young plants (KINGSBERRY) were given from strawberry laboratory, put in each cup pot having a diameter of 10 cm and cultivated up to 6 to 8-leaf stage in the greenhouse. An environment of 22+1° C., relative humidity of 60 to 80% was created in a constant temperature and humidity darkroom having length, width and height of 6 meters, 3 meters, 2.7 meters, respectively, and the young crop plants were placed such that they do not overlap. Glucose, sucrose and xylose of Comparative Example or the sugar composition of Example were dissolved in nonionized water, and congo red as a tracer material was added to prepare an aqueous solution for spray. A spreader (Dongbang spreader) was added in the recommended amount to prepare the glucose, sucrose and xylose aqueous solutions of Comparative Example. The sugar composition was diluted 1/100 unless otherwise indicated, and the Congo red concentration was 50 mg/L. The sugar aqueous solution was sprayed onto either the upper surface of leaf or the lower surface of leaf of each crop or both in such an amount that it does not flow down, and stored in the constant temperature and humidity darkroom for 21 hours to 48 hours. Acetonitrile and nonionized water were mixed at 3:7 (volume/volume) to prepare a 30% acetonitrile aqueous solution, 8 ml was put into a test tube having an outer diameter of 32 mm and a length of 200 mm and the test tube was closed with a rubber lid. The leaves sprayed with the sugar aqueous solution was picked, put and cleaned by reverse shaking at the speed of 60 rpm for 2 minutes. The cleaning solution was analyzed by high-performance liquid chromatography (HPLC) to quantify Congo red and sugar, and the sugar absorption rate was calculated by the following Equation 1. The results are shown in TABLE 1.

$$\begin{matrix}Foliar absorption rate of sugar ( \% ) = [ 1 - {(}^{t} {A}_{pp} {/}^{t} {A}_{pc} ) / {(}^{0} {A}_{pp} / {(}^{0} {A}_{pc} ) ] \times 100 \\ {t}^{} {A}_{pp} : Sugar peak area in crop leaf cleaning solution after the time t \\ {t}^{} {A}_{pc} : Congo red peak area in crop leaf cleaning solution after the time t \\ {0}^{} {A}_{pp} : Sugar peak area in crop leaf cleaning solution immediately after spraying \\ {0}^{} {A}_{pc} : Congo red peak area in crop leaf cleaning solution immediately after spraying\end{matrix} \qquad < Equation 1 >$$

TABLE 1

| Type of | Test crop (Sugar | Absorption | |
|---|---|---|---|
| sugar | concentration, mg/L) | rate (%) | Experimental condition |
| sucrose | Upper surface of cucumber | 0.0 ± 12.9 | 25° C., RH* 50-81%, 24 hours |
| | leaf (1,000) | | |
| | Upper surface of tomato leaf | 0.5 ± 2.7 | 20° C., RH 60-70%, 24 hours |
| | (4,000) | | |
| | Lower surface of tomato leaf | 1.3 ± 4.6 | 22° C., RH 70%, 24 hours |
| | (4,000) | | |
| | Upper surface of strawberry | 0.9 ± 5.4 | 22° C., RH 70%, 24 hours |
| | leaf (4,000) | | |
| | Lower surface of strawberry | 0.1 ± 5.0 | |
| | leaf (4,000) | | |
| glucose | Upper surface of cucumber | 7.6 ± 7.5 | 26° C., RH 74%, 25 hours |
| | leaf (1,000) | | |
| | Lower surface of cucumber | 24.7 ± 11.5 | |
| | leaf (1,000) | | |
| | Upper surface of tomato leaf | 0.1 ± 0.3 | 22° C., RH 70%, 24 hours |
| | (4,000) | | |
| | Lower surface of tomato leaf | 1.5 ± 0.5 | |
| | (4,000) | | |
| | Upper surface of strawberry | 2.1 ± 2.2 | 25° C., RH 60-72%, 24 hours |
| | leaf (3,000) | | |
| xylose | Upper surface of tomato leaf | 1.2 ± 4.8 | 22° C., RH 70%, 24 hours |
| | (4,000) | | |

*RH: relative humidity

TABLE 1 summarizes the absorption rate of different types of sugars as Comparative Example of the present disclosure through crop leaves. As can be seen from TABLE 1, sucrose (sugar, molecular weight 342.3) that is a condensation product of glucose (molecular weight 180.2) and fructose (molecular weight 180.2) was absorbed by tomato leaves and strawberry leaves to the maximum of 1.3%, and when considering the deviation between repetition, it may be said that sucrose is hardly absorbed. Glucose was also absorbed in a larger amount than sucrose except the lower surface of cucumber leaf, but most of glucose was absorbed by the leaves of each crop in a small amount. Accordingly, it is sufficiently thought that when most of sugars is sprayed onto plant leaves, they are not absorbed through the leaves, and remain on the surface for a long time, causing many side effects. Xylose having a slightly smaller molecular weight (molecular weight 150.1) shows a similar absorption rate to glucose by tomato leaves, and according to broad interpretation, it may be predicted that galactose or mannose that is soluble in water and has the same molecular weight as glucose will show similar plant leaf absorption to glucose, and arabinose having the same molecular weight as xylose will show similar plant leaf absorption to xylose.

### <Example 1> Preparation of Liquid Formulation of Sugar Composition for Foliar Absorption and Measurement of Plant Foliar Absorption Rate

Anhydrous glucose (α-Dextrose, Samchun Chemicals), anhydrous fructose (Sigma, USA), anhydrous xylose (Sigma, USA), anhydrous arabinose (Sigma, USA), anhydrous galactose (Sigma, USA), anhydrous mannose (Sigma, USA), anhydrous sucrose (Junsei Chemical Co, Japan), polyoxyethylene cetyl ether (made by Hannong Chemicals, Korea, hereinafter referred to as CE-x, the moles of ethylene oxide added or the number of repeat units), polyoxyethylene stearyl ether (made by Hannong Chemicals, Korea, hereinafter referred to as SE-x), polyoxyethylene lauryl ether (made by Hannong Chemicals, Korea, hereinafter referred to as LE-x), polyoxyethylene oleyl ether (made by Hannong Chemicals, Korea, hereinafter referred to as OE-x), polyoxyethylene stearyl ester (made by Hannong Chemicals, Korea, hereinafter referred to as SA-x), polyoxyethylene isododeyl ether (made by Hannong Chemicals, Korea, hereinafter referred to as IDE-x), polyoxyethylene tridecyl ether (made by Hannong Chemicals, Korea, hereinafter referred to as TDE-x), Softanol 70 (given from Hannong Chemicals, Korea), Softanol 90 (given from Hannong Chemicals, Korea), Tween 20 (polyoxyethylene sorbitan monolaurate, Junsei Chemical Co, Japan), Tween 80 (polyoxyethylene sorbitan monooleate, Junsei Chemical Co, Japan), polyoxyethylene oleyl ester (made by Hannong Chemicals, Korea, hereinafter referred to as OA-x), polyoxyethylene eicosyl ether (given from Hannong Chemicals, Korea, hereinafter referred to as C20-x), polyoxyethylene docosyl ester (given from Hannong Chemicals, Korea, hereinafter referred to as C22-x), polyoxyethylene caster ether (made by Hannong Chemicals, Korea, hereinafter referred to as CO-x), potassium chloride, potassium sulfate, calcium chloride and calcium sulfate were dissolved in nonionized water to prepare liquid sugar compositions with the composition shown in TABLE 2, TABLE 3, TABLE 4, TABLE 5, TABLE 6, TABLE 7 and TABLE 8 below.

TABLE 2

| | Composition (g/1,000 g) | | | | Cucumber leaf |
|---|---|---|---|---|---|
| Formulation | Sugar | Adjuvant | Auxiliary | | surface sugar |
| number | (100 g) | (50 g) | substance | Solvent (850 g) | absorption rate¹⁾ |
| 1 | glucose | CE-12 | — | nonionized water | 44.0 ± 7.7 |
| 2 | glucose | CE-20 | — | nonionized water | 47.3 ± 1.8 |
| 3 | glucose | SE-14 | — | nonionized water | 54.5 ± 11.0 |
| 4 | glucose | SE-20 | — | nonionized water | 57.4 ± 7.2 |
| 5 | glucose | Tween 20 | — | nonionized water | 15.7 ± 7.4 |
| 6 | glucose | Tween 80 | — | nonionized water | 19.4 ± 14.0 |
| 7 | sucrose | CE-20 | — | nonionized water | 2.7 ± 5.8 |
| 8 | sucrose | SE-20 | — | nonionized water | 16.9 ± 11.4 |

¹⁾Absorption rate at 25 ± 1° C., relative humidity of 50-81% for 21 hours

Glucose sprayed onto the cucumber leaf was absorbed by the upper surface only 7.6% for 25 hours without the help of the adjuvant (TABLE 1), but as can be seen from TABLE 2, it was confirmed that when the plurality of nonionic surfactants was added to the formulation as the adjuvant, glucose was absorbed up to 57.4% for 21 hours. It can be seen that sucrose that is not absorbed by the cucumber leaf can be absorbed up to 16.9% with the help of the adjuvant.

TABLE 3

| | Composition (g/1,000 g) | | | | Strawberry leaf |
|---|---|---|---|---|---|
| Formulation | Sugar | Adjuvant | Auxiliary | | surface sugar |
| number | (300 g) | (50 g) | substance | Solvent (650 g) | absorption rate¹⁾ |
| 9 | glucose | LE-9 | — | nonionized water | 4.6 ± 2.1 |
| 10 | glucose | LE-20 | — | nonionized water | 7.4 ± 3.7 |
| 11 | glucose | SE-7 | — | nonionized water | 8.9 ± 3.3 |
| 12 | glucose | SE-14 | — | nonionized water | 23.5 ± 4.5 |
| 13 | glucose | SE-20 | — | nonionized water | 29.0 ± 5.2 |
| | | | | | 86.7 ± 5.2²⁾ |
| 14 | glucose | SE-40 | — | nonionized water | 24.7 ± 5.5 |
| 15 | glucose | OE-8 | — | nonionized water | 13.9 ± 2.5 |
| 16 | glucose | OE-20 | — | nonionized water | 21.6 ± 4.2 |
| 17 | glucose | SA-23 | — | nonionized water | 20.1 ± 3.1 |

¹⁾Absorption rate at 25 ± 1° C., relative humidity 60-72% for 24 hours
²⁾Absorption rate by lower surface of strawberry leaf

TABLE 4

| | Composition (g/1,000 g) | | | | Strawberry leaf |
|---|---|---|---|---|---|
| Formulation | Sugar | Adjuvant | Auxiliary | | surface glucose |
| number | (300 g) | (50 g) | substance | Solvent (g) | absorption rate¹⁾ |
| 13 | glucose | SE-20 | — | nonionized water(650) | 21.7 ± 6.2 |
| 18 | glucose | TDE-15 | — | nonionized water(650) | 19.3 ± 3.4 |
| 19 | glucose | Softanol 70 | — | nonionized water(650) | 22.7 ± 10.2 |
| 20 | glucose | Softanol 90 | — | nonionized water(650) | 23.5 ± 7.1 |
| 21 | glucose | OA-20 | — | nonionized water(650) | 7.1 ± 2.0 |
| 22 | glucose | C20-10 | — | nonionized water(650) | 12.9 ± 6.5 |
| 23 | glucose | C22-10 | — | nonionized water(650) | 15.6 ± 4.0 |
| 24 | glucose | CO-25 | — | nonionized water(650) | 11.4 ± 3.0 |

¹⁾Absorption rate at 20 ± 1° C., relative humidity 75-83% for 23 hours

Glucose was absorbed on the upper surface of strawberry leaf only 2.1% for 24 hours without the help of the adjuvant as shown in TABLE 1, but as can be seen from TABLE 3 and TABLE 4, when the plurality of nonionic surfactants was added to the sugar composition as the adjuvant, glucose was absorbed by the upper surface up to 29.0% and the lower surface up to 86.7% for 24 hours, thereby adjusting the absorption rate to some extent.

TABLE 5

| | Composition (g/1,000 g) | | | | Strawberry leaf |
|---|---|---|---|---|---|
| Formulation | Sugar | Adjuvant | | | surface glucose |
| number | (300 g) | (50 g) | Auxiliary substance (g) | Solvent (g) | absorption rate¹⁾ |
| 13 | glucose | SE-20 | — | nonionized water (650 g) | 26.0 ± 8.1 |
| 25 | glucose | SE-20 | glycerol (100) | nonionized water (550 g) | 33.9 ± 9.3 |
| 26 | glucose | SE-20 | magnesium chloride (6.3) | nonionized water (644 g) | 33.8 ± 9.5 |
| 27 | glucose | SE-20 | calcium chloride (5) | nonionized water (645 g) | 25.4 ± 10.4 |
| 28 | glucose | SE-20 | potassium sulfate (5) | nonionized water (645 g) | 28.1 ± 6.7 |

¹⁾Absorption rate at 19 ± 1° C., relative humidity of 75-83% for 24 hours

As can be seen from TABLE 5, the sugar composition of the present disclosure may further increase the leaf absorption rate of sugar when several auxiliary substances are added.

TABLE 6

| | Composition (g/1,000 g) | | | | Strawberry leaf |
|---|---|---|---|---|---|
| Formulation | Sugar | Adjuvant | | | surface glucose |
| number | (300 g) | (50 g) | Auxiliary substance (g) | Solvent (g) | absorption rate¹⁾ |
| 13 | glucose | SE-20 | — | nonionized water (650 g) | 29.0 ± 5.2 |
| 25 | glucose | SE-20 | glycerol (100 g) | nonionized water (550 g) | 24.2 ± 5.2 |
| 29 | glucose | SE-20(25 g) + | — | nonionized water (645 g) | 21.6 ± 2.2 |
| | | Softano170(25 g) | | | |
| 28 | glucose | SE-20 | potassium sulfate (5.0 g) | nonionized water (645 g) | 31.3 ± 3.8 |

¹⁾Absorption rate at 19 ± 1° C., relative humidity of 40-50% for 24.5 hours

TABLE 7

| | Composition (g/1,000 g) | | | | Strawberry leaf |
|---|---|---|---|---|---|
| Formulation | | Adjuvant | Auxiliary | | surface glucose |
| number | Sugar (g) | (50 g) | substance (g) | Solvent (g) | absorption rate¹⁾ |
| 4 | glucose (100 g) | SE-20 | — | nonionized water (850 g) | 34.5 ± 4.1 |
| 13 | glucose (300 g) | SE-20 | — | nonionized water (650 g) | 39.8 ± 7.6 |
| 30 | glucose (500 g) | SE-20 | — | nonionized water (450 g) | 39.9 ± 4.3 |
| 31 | glucose(250 g) + | SE-20 | — | nonionized water (450 g) | 41.7 ± 5.2 |
| | fructose(250 g) | | | | |
| 32 | glucose (200 g) | SE-20 | — | nonionized water (750 g) | not measured |

¹⁾Absorption rate at 24 ± 1° C., relative humidity of 40-50% for 24 hours

The plant leaf absorption of the sugar composition of the present disclosure only depends on the type and concentration of the adjuvant in the formulation, and is not greatly affected by sugar concentration. TABLE 7 shows that when the glucose content in the formulation varies from 10 wt % to 50 wt % but the amount of the adjuvant is constantly maintained at 5 wt %, the strawberry leaf absorption rate slightly changes from 34% to 40%, and this shows that the amount of absorption increases in proportion to the sugar content in the formulation.

The result that even though half of glucose in the sugar composition is replaced by fructose, the sugar absorption rate by strawberry leaf is similar to the glucose formulation shows that sugars having water solubility and the same molecular weight are similarly absorbed by the same adjuvant.

TABLE 8

| | | | | | Tomato leaf |
|---|---|---|---|---|---|
| | Composition (g/1,000 g) | | | | glucose |
| Formulation | | Adjuvant | | | absorption |
| number | Sugar (400 g) | (50 g) | Auxiliary substance (g) | Solvent (550 g) | rate¹⁾ |
| 33 | glucose | SE-20 | — | nonionized water | 40.3 ± 6.4 |
| | | | | | 89.7 ± 5.7²⁾ |
| 34 | glucose (200 g) + | SE-20 | potassium chloride (5 g) | nonionized water (545 g) | not measured |
| | fructose (200 g) | | | | |
| 35 | glucose (400 g) | SE-20 | potassium chloride (5 g) | nonionized water (545 g) | Experimental Example 2 |
| 36 | xylose | SE-20 | — | nonionized water | 44.3 ± 2.4 |
| 37 | xylose (300 g) + | SE-20 | — | nonionized water | not measured |
| | arabinose (100 g) | | | | |
| 38 | galactose | SE-20 | — | nonionized water | 43 ± 5.5 |
| 39 | mannose | SE-20 | — | nonionized water | 39 ± 6.7 |

¹⁾Absorption rate at 19 ± 1° C., relative humidity of 50-70% for 24 hours
²⁾Absorption rate by lower surface of tomato leaf

As galactose and mannose that are soluble in water and have the same molecular weight as glucose were absorbed by tomato leaf at the similar ratio to glucose in TABLE 8, from TABLE 7 and TABLE 8, because glucose, fructose, galactose and mannose are all soluble in water and have the same molecular weight, it may be determined that absorption by plant leaf may be the same.

### <Example 2> Preparation of Water-Soluble Powder Formation and Water-Soluble Granule Formulation of Sugar Composition for Foliar Absorption

Water-soluble powder formulation and granule formulation were prepared with the composition of TABLE 9. First, a glucose powder, an adjuvant and a salt were mixed and stirred while heating at 80° C. to infiltrate the adjuvant into the glucose powder. While cooling at room temperature, stirring continued to change to a solid state, followed by grinding using a coffee mixer to prepare the water-soluble powder formulation. Additionally, the powder formulation was fed into an extrusion granulator with a screen having a diameter of 1 mm to prepare the granule formulation.

TABLE 9

| | Composition (g/1,000 g) | | |
|---|---|---|---|
| Formulation | | | Auxiliary |
| number | Sugar (900 g) | Adjuvant (90 g) | substance (10 g) |
| 40 | glucose | SE-20 | potassium sulfate |
| 41 | glucose (450 g) + | SE-20 | potassium sulfate |
| | fructose (450 g) | | |

Both the water-soluble powder formulation and the water-soluble granule formulation prepared as shown in TABLE 9 dissolve in water well and were suitable as high sugar content solid formulation.

### <Experimental Example 2> Measurement of Tomato Leaf Absorption Rate of Sugar Formulation Over Time

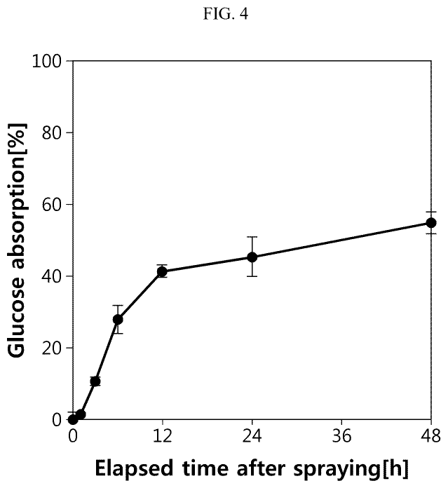

10 ml of the sugar formulation no. 35 of the present disclosure containing 400 g of glucose, 50 g of polyoxyethylene stearyl ether (20 moles of ethylene oxide added) and 5 g of potassium salt in 1 kg of sugar formulation was diluted in 1 liter of tap water, and sprayed onto the third leaf of 6.5-leaf stage tomato young plant. The leaves were collected at a regular time interval and the foliar absorption rate of glucose was measured by the same method as Experimental Example 1 and shown in the graph of FIG. 4.

As shown in FIG. 4, glucose was quickly absorbed on the tomato leaf surface up to 24 hours after spraying and was constantly continuously absorbed.

### <Experimental Example 3> Measurement of Water Absorption in Tomato Plant Sprayed with Sweetness Booster Containing Sugar as a Main Ingredient

The sugar formulation no. 30 of Example 1 was dissolved in tap water to prepare 5,000 mg/L of glucose aqueous solution. The sugar solution was sprayed onto leaves and stems of two young plants of tomato (Seogwang Tomato, made by Farm Hannong, Korea) with 5 to 6 leaves, and parts immediately above the roots were cut and placed in a 50 ml falcon tube. A tomato plant onto which the sugar solution was not sprayed was used as the non-treatment group. 40 ml of tap water was applied to the tomato plant, which in turn, was placed in a constant temperature and humidity room lit with a fluorescent light. 16 hours after spraying the sugar solution, the tomato plant body was removed, and the amount of remaining water was measured and compared with the non-treatment group.

TABLE 10

| | Amount of water | Amount of water | | Evapotranspiration |
|---|---|---|---|---|
| | remaining after | evaporated and | | compared to non- |
| Treatment group | 16 hours (ml) | transpired (ml) | Average (ml) | treatment (fold) |
| Sugar solution treatment | 9, 8 | 31, 32 | 31.5 ± 0.5 | 2.33 |
| Non-treatment | 26, 27 | 13, 14 | 13.5 ± 0.5 | 1 |

As can be seen from TABLE 10, after sugar aqueous solution treatment, evapotranspiration increased 2.33 times compared to non-treatment. This signifies that glucose was quickly absorbed into the aerial parts of tomato, the osmotic pressure of the mesophyll cell sharply increased, and accordingly water absorption through the roots greatly increased. This shows that the metabolism in the plant body such as nutrients absorption and translocation may be activated by spraying the sugar composition of the present disclosure in a weak light condition or at low growth temperature.

### <Experimental Example 4> Strawberry Crop Enlargement Effect of Sugar Composition

Five strawberry young plants, each having 5 to 6 leaves were randomly taken and divided into a treatment group and a non-treatment group. The glucose formulation no. 32 of the above example was dissolved in tap water to prepare a 2,000 mg/L of aqueous solution which was sprayed two times at 3-day intervals. Tap water was sprayed on the control group. 5,000 mg/L of glucose aqueous solution was prepared by the same method 3 days after spraying the sugar solution at the second time and sprayed two times at 3-day intervals. The experiment was performed at an apartment veranda where sunlight comes in the day time half of the time and the nighttime temperature is 10° C. and the daytime temperature is 25° C. 3 days after the last treatment, only the aerial parts except roots were cut, and the fresh weight was measured and compared with the non-treatment group to calculate the growth promotion effect of the sugar composition on the strawberry young plant.

TABLE 11

| | Aerial part | Fresh weight increase |
|---|---|---|
| Treatment group | weight (g) | compared to non-treatment |
| Sugar solution treatment | 26.0 ± 3.4 | 1.11 |
| Non-treatment | 23.4 ± 3.1 | 1 |

As can be seen from TABLE 11, it shows that when the sugar composition is sprayed onto the strawberry young plant, the fresh weight may increase in an environment that is not favorable for growth.

### <Experimental Example 5> Cherry Tomato Sugar Content Increase and Yield Increase Effect of Sugar Composition

10 plants grown by grafting TY Tini cherry tomato seedlings onto rootstocks in a plant nursery were purchased, put in each pot having a diameter 20 cm and a height of 15 cm and cultivated in greenhouse. When a flower first blooms (first flowering), 8 tomato plants were selected and divided into a control group and a treatment group of four plants each, and Domadoton was sprayed onto the flowers at 3-day intervals until the second flower falls in order to promote fruit setting. When the first flower of cherry tomato begins to turn red, the sugar composition no. 35 of Example 1 was diluted in tap water 100 times in volume and sprayed on the entire plant body three times at 3 to 4-day intervals. Only red ripe fruits were picked for each pot 13 days after the first treatment, their weight was measured, the sugar content was measured four times using a non-destructive sugar content meter (PAL-HIKARI 3 Mini, made by ATAGO, Japan) while turning each fruit by 90°, and the measurements were averaged. TABLE 12 summarizes the comparison result with the non-treatment group.

TABLE 12

| | | Sugar formulation | Increase |
|---|---|---|---|
| | Non-treatment | treatment | (%) |
| Total fruit weight(g) | 350.4 | 435.2 | 124 |
| Tomato sugar content | 9.0 ± 0.6 | 11.6 ± 0.2 | 129 |
| (Brix) | | | |

As can be seen from TABLE 12, the sugar composition of the present disclosure was sprayed onto the leaves of unripe cherry tomatoes, resulting in 24% increase in ripe cherry tomato harvest compared to the non-treatment control group, and increase in sugar content by 2.6 Brix (29%). Additionally, the sugar content increase effect is highly reliable due to a low standard deviation. The increased yield of mature fruits results from earlier ripening time by the sugar composition treatment, and consequential earlier ripening of some of secondary flowers.

### <Experimental Example 6> Strawberry Sugar Content Increase Effect of Sugar Composition

Some patches in the strawberry research center that breeds KINGSBERRY cultivar were rented. 30 strawberry plants being transplanted and cultivated were used as a test group and each of treatment group and non-treatment group was placed with 3 repetitions. From early December to mid December during which strawberry begins second flowering, the sugar composition 33 of Example 1 was sprayed five times at 3 to 4-day intervals. The sugar composition no. 33 was diluted in tap water 100 times in volume to prepare 800 ml, and the three test groups were all treated, and the control group was treated with tap water. 3 days after each treatment, immediately before the next spraying, 10 strawberries having the similar size were harvested from each of the treatment group and the non-treatment group and squeezed to get juice to measure the sugar content using a sugar content meter (Cas digital sugar content meter, Cas, Korea). The results are shown in TABLE 13. Additionally, the firmness of fruits is an indicator of shelf life of strawberry and was measured using a digital fruit firmness tester (FR-5120, Taiwan).

TABLE 13

| | | | Sugar | |
|---|---|---|---|---|
| | | | composition | |
| | | Non-treatment | treatment | Increase |
| Sugar content | December 17 | 9.7 ± 0.1 | 10.8 ± 0.1 | 1.1 |
| (Brix) | December 21 | 9.9 ± 0.2 | 11.6 ± 0.2 | 1.7 |
| | December 24 | 10.6 ± 0.2 | 12.3 ± 0.4 | 1.7 |
| Firmness | December 17 | 10.1 ± 0.2 | 10.9 ± 0.6 | 0.7 |
| (g/mm²) | December 21 | 10.6 ± 0.7 | 12.1 ± 0.8 | 1.5 |
| | December 24 | 9.9 ± 0.3 | 11.8 ± 0.7 | 1.9 |

As can be seen from TABLE 13, when the sugar composition for foliar absorption was sprayed on the leaves, the sugar content in strawberry increased by 1.1 to 1.7 Brix compared to the non-treatment group. Additionally, the fruit firmness that greatly affects the product quality also increased about 20% during distribution of strawberry.

### <Experimental Example 7> Grape Sugar Content Increase in Sugar Composition for Foliar Absorption

In rainproof cultivation, three Campbell Early grape trees in the sixth year of harvest were repeatedly selected and placed. When each branch has about 9 mature leaves, young buds were removed to grow two grapes in a branch. In early June, when a grape berry is as large as a bean in size, bags were put on the grapes. When the grape berries begin to turn red, the glucose-containing sugar composition no. 40 of Example 1 was dissolved and diluted in tap water 300 times, and sprayed on the grape trees from bottom to top in such an amount that the sugar solution does not flow down. The spray treatment was performed a total of three times at 3-day intervals after the first treatment until the grapes all ripen. The non-treatment group was spray-treated with tap water. 5 grapes were randomly harvested from each tree, and each cluster of grapes was put in a mixer to get juice. The sugar content in the thin juice was measured and averaged, and the results are shown in TABLE 14.

TABLE 14

| | Sugar content | Sugar content |
|---|---|---|
| Treatment | (Brix) | increase (Brix) |
| Tap water treatment group | 14.5 ± 0.4 | — |
| Sugar formulation treatment group | 17.2 ± 0.7 | 2.7 |

As can be seen from TABLE 14, it was confirmed that in the similar way to Experimental Example of strawberry and cherry tomato, the sugar content in grape greatly increased, and thus the composition of the present disclosure can be equally applied to not only fruits but also fruit trees.

### <Experimental Example 8> Strawberry Two-Spotted Spider Mites Control of Sugar Composition

Strawberry young plant (KINGSBERRY) was planted in a cup pot having a diameter of 10 cm, fed with a nutrient solution and cultivated in greenhouse for 3 months. Pots where two-spotted spider mites occurred were gathered and cultivated in isolated state. 4 pots in which the mite population density in mature leaf is 4 to 6 in each leaf were selected, the petiole of target leaf was marked with a wire, the density was adjusted to 5 mites in each leaf, and the treatment group and the non-treatment group were placed in isolated state. The sugar composition no. 33 of Example 1 was diluted in tap water 100 times and evenly sprayed onto the entire aerial part including the upper surface and lower surface of strawberry leaf. The non-treatment group was spray-treated with tap water. The number of mites living on the target leaf was counted 24 hours after the treatment and the pest control effect was calculated by comparing with the non-treatment group and is shown in TABLE 15. The verified strawberry pot was treated with tap water or the diluted solution of the sugar composition again after 3 days and cultivated by bottom watering for another 2 weeks, and the pest control effect was evaluated again.

TABLE 15

| Treatment | Number of live mites | Pest control (%) |
|---|---|---|
| Tap water treatment group | 3, 4, 3, 5, 2 | 32 ± 10 |
| Sugar formulation treatment | 1, 0, 0, 1, 0 | 96 ± 4 |
| group | | |

The tap water spray treatment controlled some of the mites occurred in strawberry, but 96% pest control was achieved by the first spray treatment of the glucose-containing plant booster of the present disclosure. Subsequently, any mite was not found in the strawberry having undergone second treatment after 2 weeks and the pest control effect of the sugar formulation was perfect. In contrast, mites prevailed on the tap water treatment group again and several mites were found on old leaves.

### <Experimental Example 9> Cucumber Powdery Mildew Control of Sugar Composition

Cucumber (Korean White, made by Dongbu Farm Hannong, Korea) grown in greenhouse was cultivated for a long time to create an environment in which naturally occurring powdery mildews spread. Cucumber was planted in a cup pot having a diameter of 10 cm, and cultivated in the greenhouse up to 4-leaf stage so that powdery mildew naturally propagates to the young plant, and when two or three powdery mildew spots were found on two foliage leaves of cucumber, it was used in the pest control experiment. Tap water was added to the sugar composition of the present disclosure 33 to dilute 100 times and 200 times, and the diluted solution was evenly sprayed on all leaves of young cucumber plant infected with powdery mildew in such an amount that it does not flow down. The tap water spray treatment group and the non-treatment group were placed together with the sugar composition treatment group. The experiment was performed on 5 individuals in a repetitive manner. Verification was performed by counting the number of powdery mildew lesions on the leaf surface after cultivating for 3 days by bottom watering. The powdery mildew control effect was calculated by comparing with the non-treatment group, and is shown in TABLE 16. The verified cucumber was treated with tap water or the diluted solution of the sugar composition again after 3 days and cultivated for another 3 days by bottom watering, and the powdery mildew control effect was evaluated again.

TABLE 16

| | Number of lesions | Pest control |
|---|---|---|
| Treatment | (average of 5 plants) | rate (%) |
| Non-treatment group | 30.8 ± 9.3 | — |
| Tap water treatment group | 26.0 ± 27.0 | 15.6 |
| Sugar composition treatment | 9.0 ± 8.1 | 70.8 |
| group ( 1/200) | | |
| Sugar composition treatment | 9.0 ± 4.6 | 70.8 |
| group ( 1/100) | | |

As can be seen from TABLE 16, the number of lesions in the non-treatment group increased 10 times or more 3 days after the start of the experiment and disease outbreaks continued, but the number of lesions in the sugar composition treatment group was much smaller and the pest control effect reached 70%. Little or no lesion was found 3 days after second treatment of the sugar composition, so it was effective in controlling powdery mildew, and any phytotoxicity symptoms or stain caused by the remaining sugar were not found.

What is claimed is:

1. A sugar composition for foliar spray, comprising:
10 wt % or more of sugar; and
1 wt % or more of an adjuvant.

2. The sugar composition for foliar spray according to claim 1, wherein the sugar includes at least one selected from the group consisting of glucose, fructose, xylose, arabinose, galactose, mannose and sucrose.

3. The sugar composition for foliar spray according to claim 1, wherein the adjuvant includes at least one selected from the group consisting of fatty alcohol polyoxyethylene ether, polyoxyethylene fatty acid ester, polyoxyethylene sorbitan fatty acid ester and polyoxyethylene sucrose fatty acid ester.

4. The sugar composition for foliar spray according to claim 3, wherein a fatty alcohol in the fatty alcohol polyoxyethylene ether includes at least one selected from the group consisting of butanol, octanol, a decyl/dodecyl alcohol mixture, lauryl alcohol, isododecyl alcohol, tridecyl alcohol, secondary alcohol having 12 to 14 carbon atoms, cetyl alcohol, stearyl alcohol, oleyl alcohol and castor oil.

5. The sugar composition for foliar spray according to claim 3, wherein a fatty acid in the polyoxyethylene fatty acid ester includes at least one selected from the group consisting of lauric acid, stearic acid, oleic acid and coconut fatty acid.

6. The sugar composition for foliar spray according to claim 1, wherein the sugar composition further includes an inorganic salt.

7. The sugar composition for foliar spray according to claim 6, wherein the inorganic salt includes at least one selected from the group consisting of potassium chloride, potassium sulfate, potassium carbonate, potassium phosphate, potassium nitrate, calcium chloride, magnesium chloride and magnesium sulfate.

8. The sugar composition for foliar spray according to claim 1, wherein the plant includes at least one selected from the group consisting of vegetables, fruits, grains and fruit trees.

9. A liquid formulation of a sugar composition for foliar spray, comprising:
the composition according to any one of claims 1 to 8; and
at least one type of liquid selected from the group consisting of water and an aqueous organic solvent.

10. A water-soluble powder formulation of a sugar composition for foliar spray wherein all ingredients of the sugar composition according to any one of claims 1 to 8 are mixed in a form of powder.

11. A water-soluble granule formulation of a sugar composition for foliar spray wherein all ingredients of the sugar composition according to any one of claims 1 to 8 are mixed and granulated to easily dissolve in water.

12. The sugar composition for foliar spray according to any one of claims 1 to 8, wherein the sugar composition is used to increase sugar content in the plant, or enhance a size or number of plants.

13. The sugar composition for foliar spray according to any one of claims 1 to 8, wherein the sugar composition is used for plant pest control.

14. A method of using a sugar composition for foliar spray, the method comprising:
preparing the sugar composition according to any one of claims 1 to 8;
mixing the sugar composition with water to prepare a sugar aqueous solution; and
foliar spraying the sugar aqueous solution one or more times to at least one type of plant selected from the group consisting of vegetables, fruits, grains and fruit trees.

15. The method of using the sugar composition for foliar spray according to claim 14, wherein the method is used to improve sugar content in the plant, or enhance a size or number of plants.

16. The method of using the sugar composition for foliar spray according to claim 14, wherein the method is used to control pests in the plant or prevent cold weather damage.
